(19) United States
(12) Patent Application Publication
(10) Pub. No.: US 2013/0175311 A1
(43) Pub. Date: Jul. 11, 2013

(54) PACKING MATERIAL DISPENSER AND METHOD

(71) Applicant: Paul Soucek, Gilbert, AZ (US)

(72) Inventor: Paul Soucek, Gilbert, AZ (US)

(21) Appl. No.: 13/345,537

(22) Filed: Jan. 6, 2012

(51) Int. Cl. B65H 35/10; B65H 49/00; B26F 3/02

(52) U.S. Cl. 225/53

(57) ABSTRACT

A packaging material dispenser has a container having a hollow interior and an open top section. A cover member is attached to the container and positioned over the open top section of the container. An opening is formed in a central area of the cover member. A cutting device is positioned above the opening.

### FIELD OF THE INVENTION

This invention relates to packing material, and more specifically, to a device for dispensing paper packing material.

### BACKGROUND OF THE INVENTION

Packaging materials are widely used industrially and domestically to cushion products ranging from delicate equipment to office supplies to prevent damage to the products during shipment and handling. Presently, the most popular type of packing material used is the foam peanut. Foam peanuts provide a low density, flexible packaging material that protects a product from damage without adding significantly to the weight of the product when shipped. Although conventional expanded foam materials adequately cushion a product, disposal of the materials is difficult because they may not be biodegradable or recyclable

Several problems are associated with conventional packaging materials, such as expanded polystyrene peanuts. Safety problems arise during manufacture because the peanuts are formed from styrene monomer which is hazardous to workers if inhaled or ingested. The packing peanuts also accumulate static charges that cause them to stick to a product when the peanuts are closely packed about the product within a shipping carton. Furthermore, the nonbiodegradable peanuts are often discarded after use, adding to existing landfill waste disposal problems.

Recycled newspaper has been used to form a biodegradable, recyclable packaging material. These materials, formed from aqueous slurries of chopped newspapers, are molded into thin hollow walled shells or are extruded as pellets. Although these materials employ waste paper materials, they have several drawbacks. The materials generally require a significant amount of storage space before they are reused or transported for recycling

Therefore, a need existed to provide a device and method to overcome the above problem.

### SUMMARY OF THE INVENTION

A packaging material dispenser has a container having a hollow interior and an open top section. A cover member is attached to the container and positioned over the open top section of the container. An opening is formed in a central area of the cover member. A cutting device is positioned above the opening.

### BRIEF DESCRIPTION OF THE DRAWINGS

FIG. 1 is a perspective view of one embodiment of the present invention;

FIG. 2 is a rear perspective view of the embodiment of FIG. 1;

FIG. 3 is an exploded view of the embodiment of FIG. 1;

FIG. 4 is a bottom perspective view of an inner container used in the embodiment shown in FIG. 1;

FIG. 5 is a rear view of the inner container shown in FIG. 4;

FIG. 6 is a side view of the inner container shown in FIG. 4;

FIG. 7 is a bottom view of the inner container shown in FIG. 4; and

FIG. 8 is a top view of the inner container shown in FIG. 4.

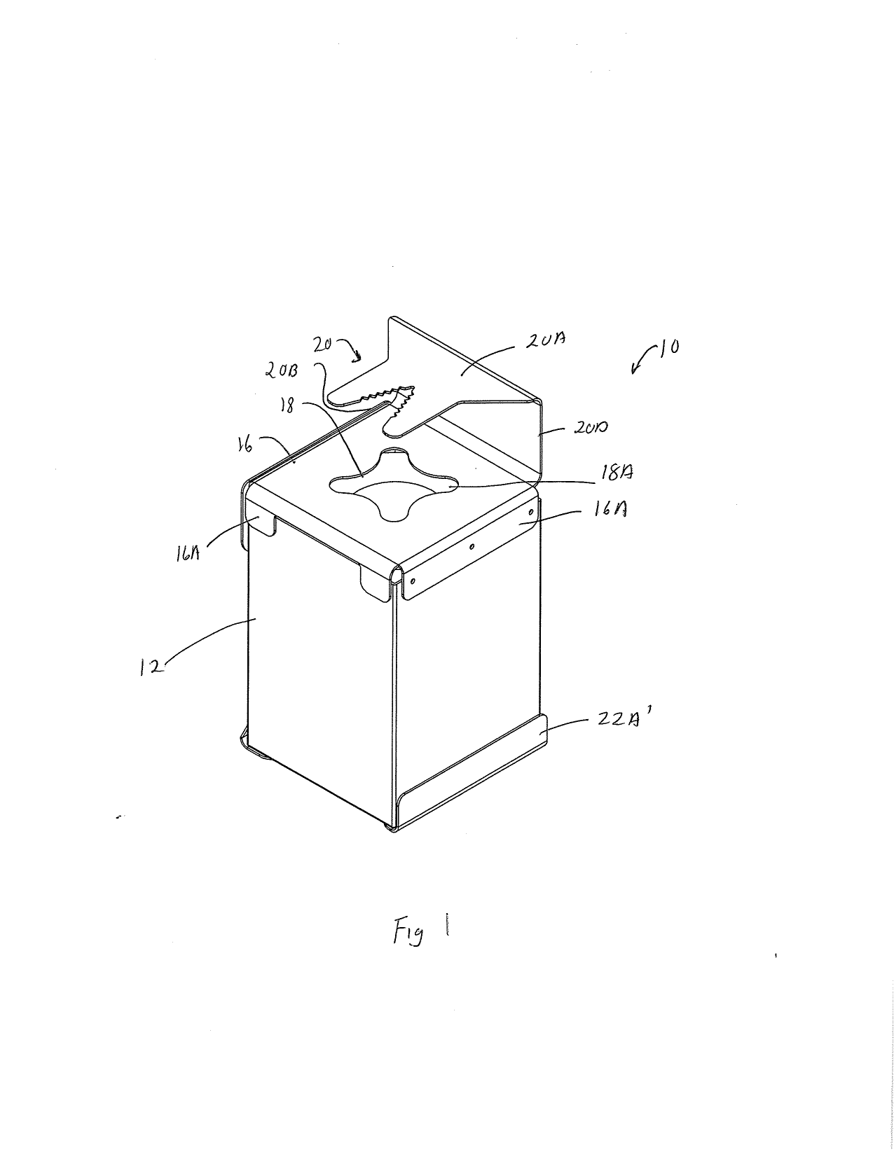

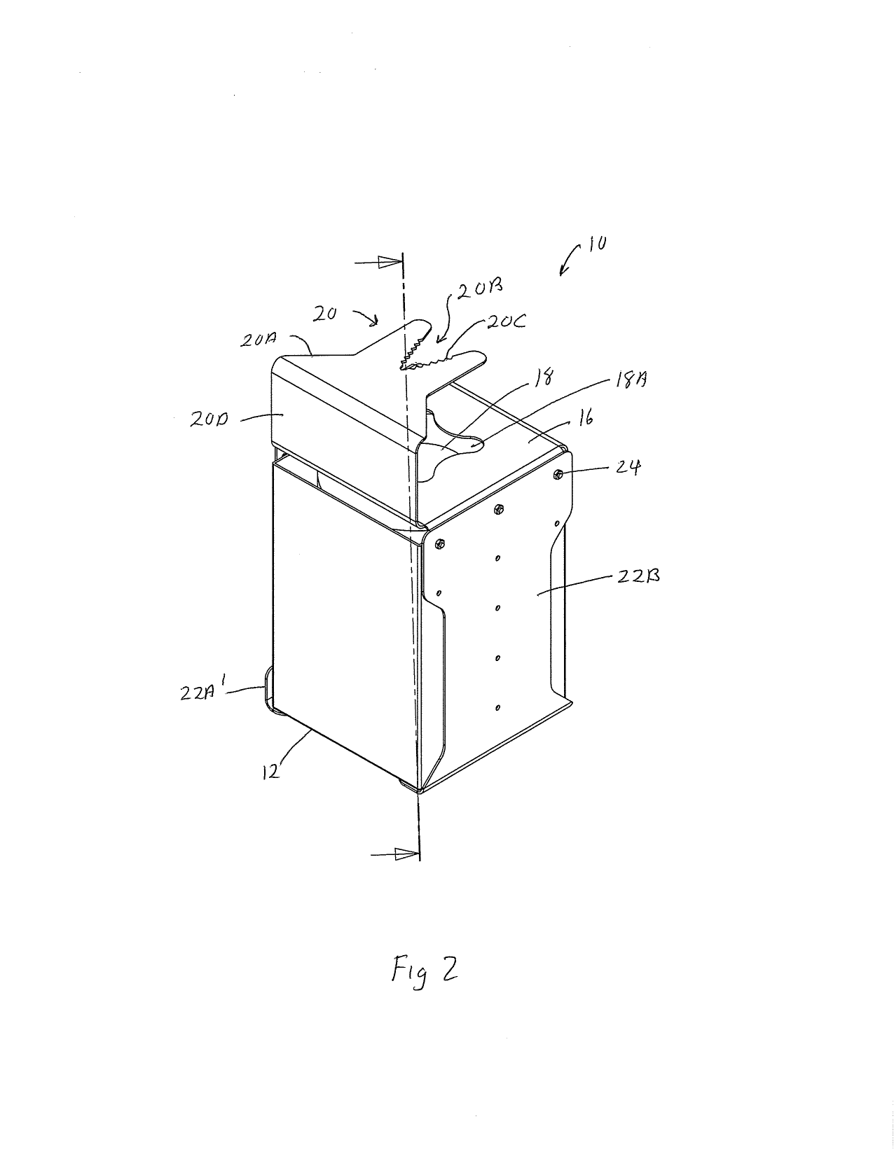

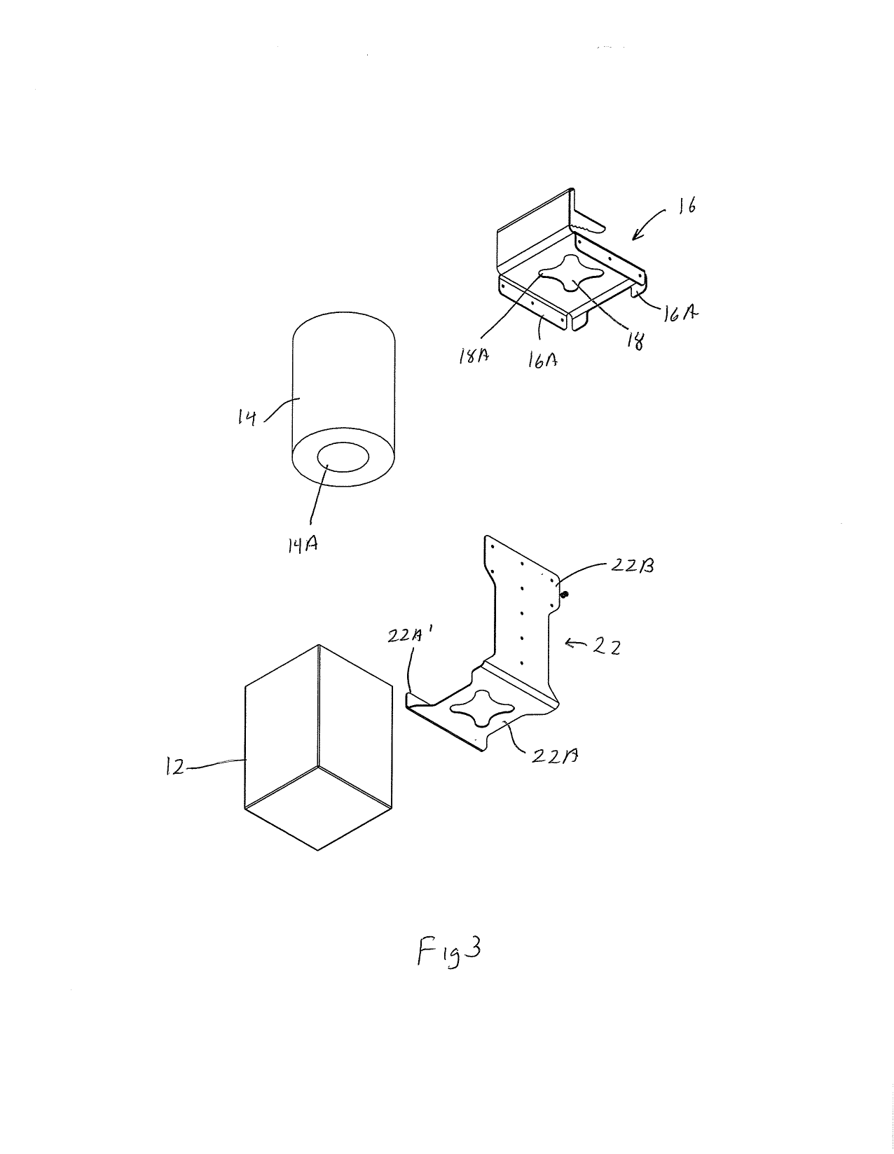

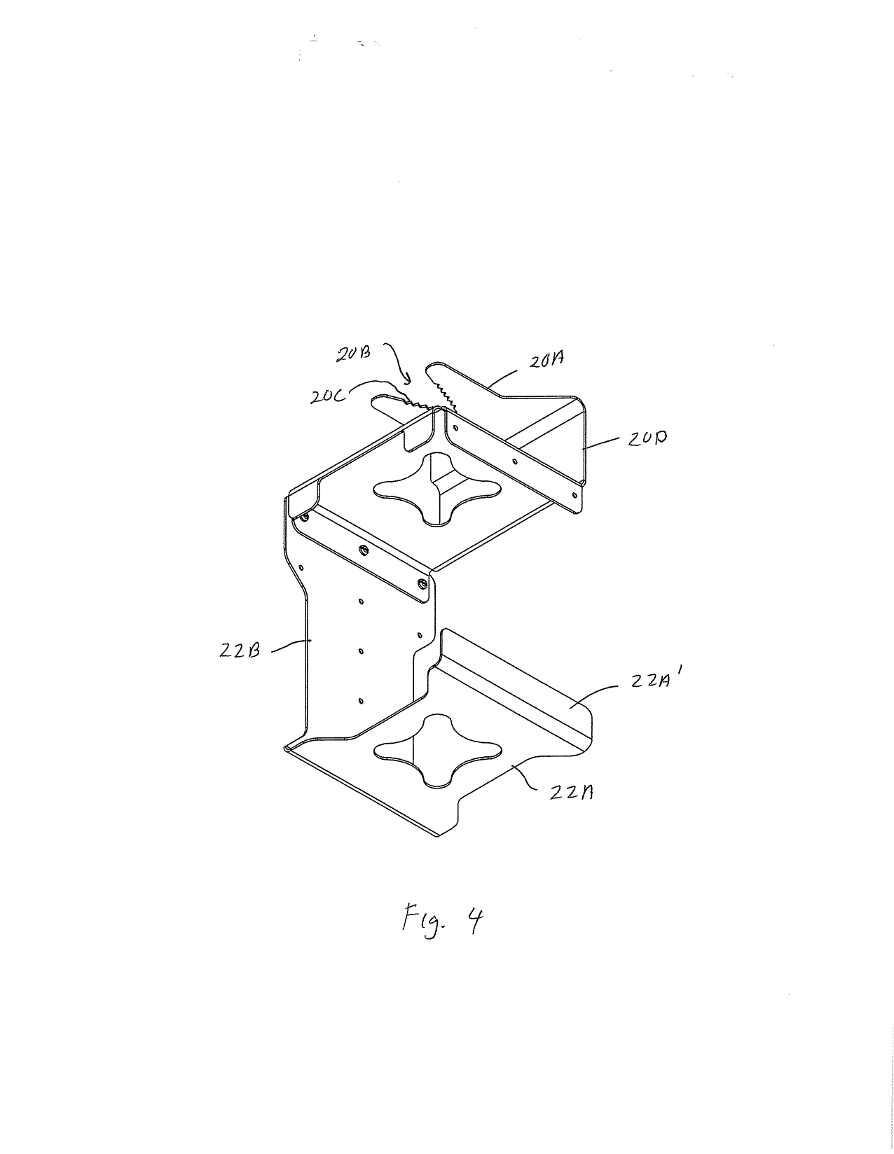

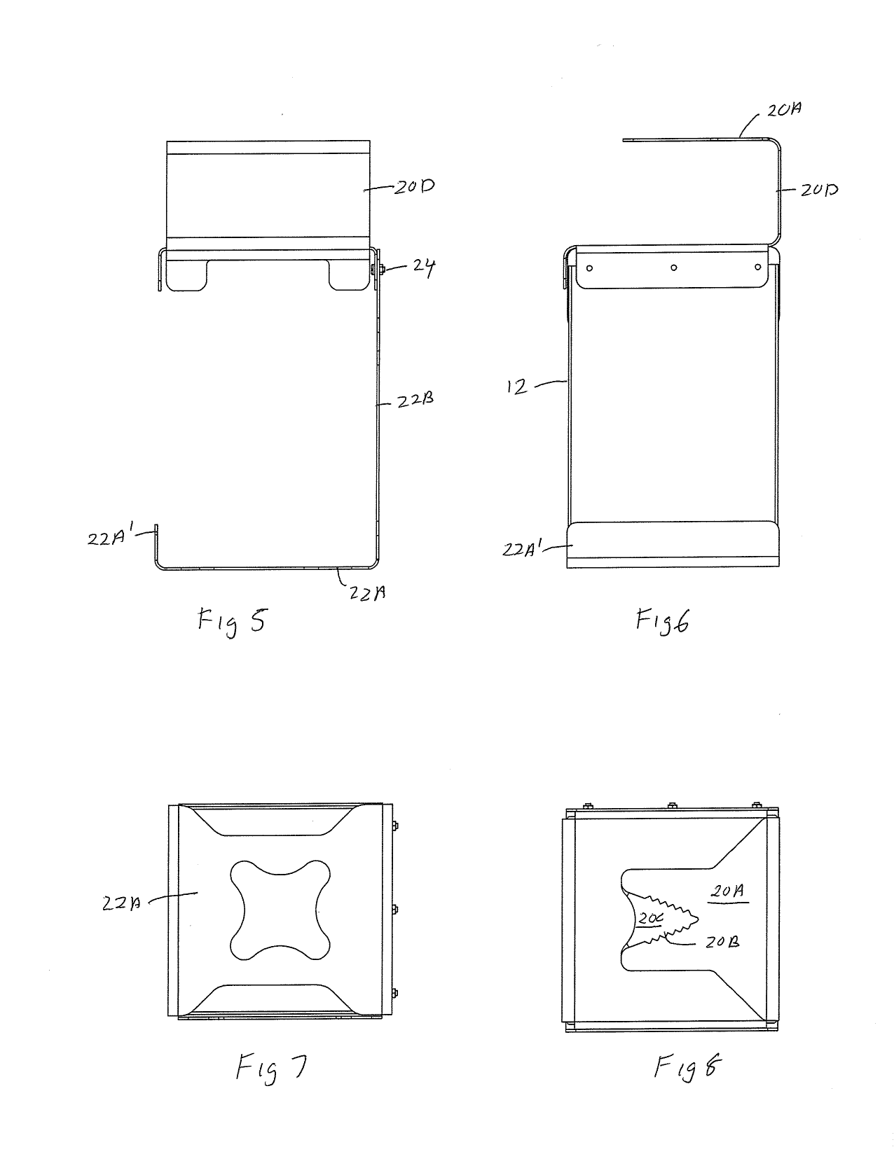

Common reference numerals are used throughout the drawings and detailed description to indicate like elements.

### DETAILED DESCRIPTION

Referring now to the figures, a dispenser 10 is shown. The dispenser 10 may be used to quickly and efficiently turn paper material into an effective void fill material to protect products during shipping. The dispenser is compact in size thereby requiring minimal area for set-up and storage. The dispenser 10 allows for the paper packing material to be neatly guided into the package without any overflow or spillage as in the case with prior art foam peanuts. The dispenser 10 further does not require the use of any motor thereby making for a quiet device appropriate for non-industrial settings.

The dispenser 10 may have a container member 12. The container member 12 may come in different shapes. In the embodiment shown in the Figures, the container member is a rectangular shaped container having an open top. However, this is shown as an example and should not be seen in a limiting manner. The container member 12 may be formed of a light weight but hard material. In accordance with one embodiment, the container member 12 may be formed of a hardened plastic, aluminum, tin or the like. The listing of the above is given as an example and should not be seen in a limiting manner.

The container member 12 may be used to hold paper packing material 14 and to allow the paper packing material 14 to be dispensed through a cover member 16. In the present embodiment, the paper packing material 14 is on a roll 14A. The container member 12 may be used to hold the roll 14A to allow a sheet of the paper packing material to rotate off of the roll 14A to be dispensed through the cover member 16.

The cover member 16 may be attached to an opening formed in a top of the container member 12. In general, the cover member 16 is removably coupled to the container member 12. In accordance with one embodiment of the present invention, the cover member 16 may have one or more flaps 16A. The flaps 16A may be used to secure the cover member 16 to the container member 12. The flaps 16A are fitted over the edges of the container member 12 to secure the cover member 16 to the container member 12. The cover member 16 may be formed of the same or similar material as the container member 12.

The cover member 16 may have an opening 18 formed there through. The opening 18 may be formed in a central area of the cover member 16. The opening 18 may be used to allow the sheet of the paper packing material 14 to be dispensed through a cover member 16. In the present embodiment, the opening 18 may have one or more elongated sections 18A. The elongated sections 18A may be used to aid in the tearing of the paper packing material 14.

A cutting device 20 may be coupled to the cover member 16. The cutting device 20 may be used to help in cutting the paper packing material 14 to be dispensed through a cover member 16. In the present embodiment, the cutting device 20 is positioned above the opening 18 formed in the cover member 16. The cutting device 20 may be formed of a plate member 20A. A cut-out 20B may be formed in the plate member 20A. The edges of the cut-out 20B may be jagged 20C. The jagged edges 20C may provide a mechanism for cutting the paper packing material 14 to be dispensed. A support plate 20D may extend up from the cover member 16. The support plate 20D may be used to secure and hold the plate member 20A in position.

The dispenser 10 may have a support housing 22. In the embodiment shown in the figures, the support housing may be comprised of a bottom plate 22A. The bottom plate 22A may have a bottom plate flap 22A′. One or more wall members 22B may extend up from the bottom plate 22A. In accordance with one embodiment, at least one of the flaps 16A of the cover member 16 is secured to one of the wall members 22B. One or more securing device 24 may be used to secure the flaps 16A to the wall member 22B. The securing devices 24 may be screws, rivets, or the like. It should be noted that other methods may be used to secure the cover member 16 to the wall member 22B.

In accordance with one embodiment, one way to secure the support housing 22 to the container member 12 is as follows. The bottom plate 22A may be positioned under the container member 12. The bottom plate flap 22A′ may be folded so that it engages the container member 12. The one or more wall members 22B may extend up a side surface of the container member 12. Another one or more flaps 16A of the cover member 16 may be slid over the container 12 to secure the support housing 22 to the container member 12.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A packaging material dispenser comprising:
a container having a hollow interior and an open top section;
a cover member attached to the container and positioned over the open top section of the container;
an opening formed in a central area of the cover member; and
a cutting device positioned above the opening.
